(19) United States
(12) Patent Application Publication
(10) Pub. No.: US 2003/0077150 A1
(43) Pub. Date: Apr. 24, 2003

(54) Substrate processing apparatus and a method for fabricating a semiconductor device by using same

(75) Inventors: Tomoyuki Matsuda, Tokyo (JP); Ryuji Ishitsuka, Tokyo (JP); Tatsuhisa Matsunaga, Tokyo (JP); Kouichi Noto, Tokyo (JP)

Correspondence Address: Eugene Mar, BACON & THOMAS, PLLC, Fourth Floor, 625 Slaters Lane, Alexandria, VA, 22314-1176, US

(73) Assignee: Hitachi Kokusai Electric Inc., Tokyo (JP)

(21) Appl. No.: 10/255,708

(22) Filed: Sep. 27, 2002

(30) Foreign Application Priority Data
Oct. 11, 2001 (JP) 2001-313792

(51) Int. Cl. B65G 49/07

(52) U.S. Cl. 414/217

(57) ABSTRACT

A substrate processing apparatus includes a process room for treating one or more substrates, an antechamber of a loadlock type installed to be adjoined to the process room, and a buffer chamber installed to be adjoined to the antechamber, the buffer chamber being maintained at an atmospheric pressure while the one or more substrates are transferred from a carrier for accommodating the one or more substrates to the buffer chamber and at a vacuum condition while the one or more substrates are transferred from the buffer chamber to the antechamber. The buffer chamber is equipped with a loading port for loading the carrier at a top or a side portion thereof. The antechamber is equipped with a stocker for storing one or more product substrates or/and one or more dummy substrates therein. The elevator is arranged at a corner portion of the antechamber in order to reduce dead space.

### FIELD OF THE INVENTION

The present invention relates to a substrate processing method and apparatus to be used in fabricating a semiconductor device; and more particularly, to a substrate processing apparatus useful for heat-treating a substrate used as a workpiece, e.g., a semiconductor wafer (hereinafter referred to as a wafer) on which an integrated circuit including a semiconductor element is mounted, while maintaining the surface of the substrate in a high clean condition, in a method for fabricating a semiconductor integrated circuit device (hereinafter referred to as a IC).

### BACKGROUND OF THE INVENTION

A natural oxide film formed on a wafer has been required to be very small as high integration of an IC is in progress. To make the natural oxide film very small, it is important that a wafer is not in contact with an atmospheric air. Therefore, to prevent the wafer from making a contact with the atmospheric air, a substrate processing apparatus configured to transfer the wafer under a nitrogen atmosphere or a vacuum condition has been developed.

As such a conventional substrate processing apparatus, a vertical apparatus for performing a diffusion and a CVD (chemical vapor deposition) process is disclosed in Japanese Patent Application Laid-open No. 1995-101675. The vertical diffusion and CVD apparatus includes a cassette chamber capable of receiving a cassette (wafer carrier) having a plurality of wafers mounted therein under an air-tight condition, a loadlock chamber (wafer loading-transferring chamber) having a wafer loading-transferring device for loading and transferring the wafer between a cassette disposed in the cassette chamber and a boat, and a reaction chamber (process tube) which the boat positioned in the loadlock chamber is loaded into or unloaded from, wherein the cassette chamber is connected to the loadlock chamber, and the loadlock chamber to the reaction chamber, each being connected through a gate valve (or sluice valve). The atmosphere of the loadlock chamber can be replaced with a nitrogen gas without exhaustion under a vacuum condition.

However, in case a FOUP (front opening unified pod; hereinafter, pod) is used as a wafer carrier, a width of the aforementioned vertical diffusion and CVD apparatus increases to thereby cause a problem in which an area occupied by the apparatus (footprint) increases. In the vertical diffusion and CVD apparatus as mentioned above, two types of wafer carriers are used. One is an open cassette having a box-shaped body with a pair of open sides. The other is a pod capable of blocking up whole sides of the box-shaped body to transfer the wafers without contamination. In case where the pod is used as a wafer carrier, however, the pod opener for opening and closing the pod by putting or removing a cap of the pod, and the wafer loading-transferring device for extracting or putting in the wafers with regard to the opened pod are arranged in front of the cassette chamber (a loading-transferring chamber into which the wafer is loaded), thereby making the width of the vertical diffusion and CVD apparatus wider.

In the meantime, to reduce the formation of the natural oxide film or the contamination by organic materials on the wafers while transferring the wafer outputted from the wafer carrier, it is preferred to transfer the wafer under vacuum atmosphere rather than nitrogen atmosphere and for this, it is required to maintain the atmosphere of an antechamber under vacuum condition. However, since the antechamber has a large capacity, it is required to spend needlessly long time to make the room vacuum. For such reasons, it is preferable that the antechamber is maintained under a vacuum condition if possible.

### SUMMARY OF THE INVENTION

It is, therefore, an object of the present invention to provide a substrate processing apparatus and a method for fabricating a semiconductor device, which are capable of reducing a footprint of the apparatus while maintaining a high cleanliness condition for the wafer surface.

In accordance with a first aspect of the invention, there is provided a substrate processing apparatus including: a process room for treating one or more substrates; an antechamber of a loadlock type installed to be adjoined to the process room; and a buffer chamber installed to be adjoined to the antechamber, the buffer chamber being maintained at an atmospheric pressure while the one or more substrates are transferred from a carrier for accommodating the one or more substrates to the buffer chamber and at a vacuum condition while the one or more substrates are transferred from the buffer chamber to the antechamber, wherein the buffer chamber is equipped with a loading port for loading the carrier at a top or a side portion thereof.

In accordance with a second aspect of the invention, there is provided a substrate processing apparatus including: a process room for treating one or more substrates; an antechamber of a loadlock type installed to be adjoined to the process room; and a buffer chamber installed to be adjoined to the antechamber, the buffer chamber being maintained at an atmospheric pressure while the one or more substrates are transferred from a carrier for accommodating the one or more substrates to the buffer chamber and at a vacuum condition while the one or more substrates are transferred from the buffer chamber to the antechamber, wherein the antechamber is equipped with a stocker for storing one or more product substrates or/and one or more dummy substrates therein.

In accordance with a third aspect of the invention, there is provided a method for fabricating a semiconductor device comprising the steps of: transferring one or more substrates from a carrier for accommodating the one or more substrates to a buffer chamber at an atmospheric pressure; transferring the one or more substrates from the buffer chamber to an antechamber of a loadlock type at a vacuum condition; transferring the one or more substrates from the antechamber to a process room at a vacuum condition; and processing the one or more substrates in the process room, wherein the buffer chamber is installed to be adjoined to the antechamber, the buffer chamber is equipped with a loading port for loading the carrier at a top or a side portion thereof, and the antechamber is installed to be adjoined to the process room.

### BRIEF DESCRIPTION OF THE DRAWINGS

The above and other objects and features of the present invention will become apparent from the following description of preferred embodiments given in conjunction with the accompanying drawings, in which:

FIG. 1 shows a partially omitted perspective view of a batch-type CVD apparatus in accordance with a first preferred embodiment of the present invention;

FIG. 2 describes a vertical cross-sectional view of the batch-type CVD apparatus of FIG. 1;

FIG. 3 illustrates a horizontal cross-sectional view taken along the line III-III shown in FIG. 2;

FIG. 4 offers a horizontal cross-sectional view taken along the line IV-IV shown in FIG. 2;

FIG. 5 provides a cross-sectional view taken along the line V-V shown in FIG. 4;

FIG. 6 depicts a cross-sectional view of the batch-type CVD apparatus of FIG. 1 with a boat loaded into a process tube;

FIG. 7 represents a partially omitted perspective view of a batch-type CVD apparatus in accordance with a second preferred embodiment of the present invention; and

FIG. 8 shows a horizontal cross-sectional view of the batch-type CVD apparatus of FIG. 7.

### DETAILED DESCRIPTION OF THE PREFERRED EMBODIMENTS

Hereinafter, a first preferred embodiment of the present invention will now be described with reference to the accompanying drawings.

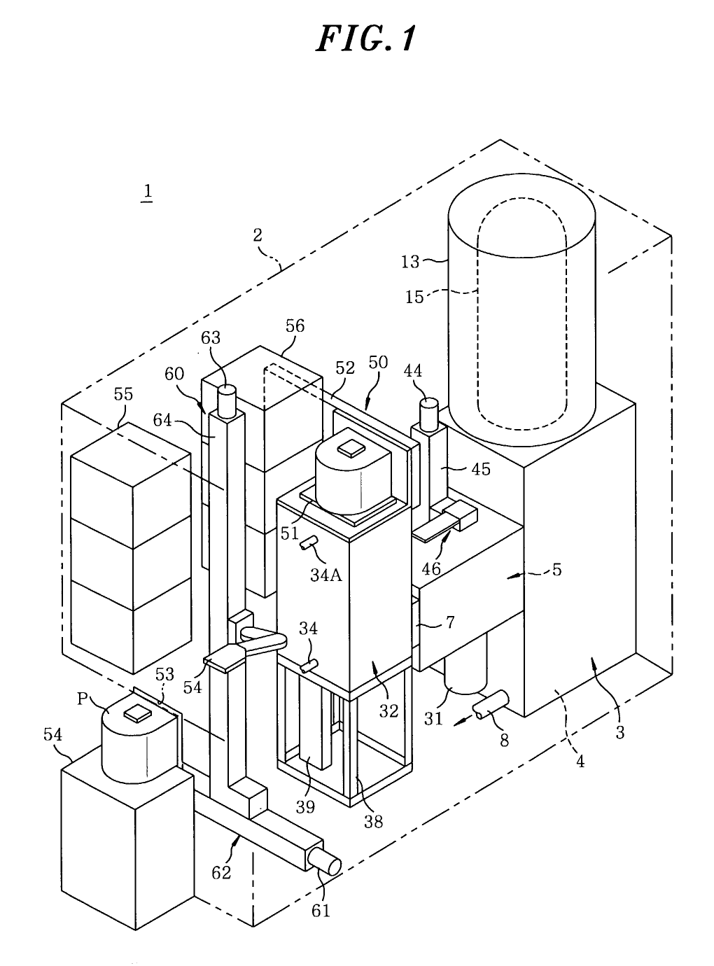

In the first preferred embodiment of the present invention, a substrate processing apparatus is a batch-type vertical apparatus for performing a diffusion and a CVD process (hereinafter referred to as a batch-type CVD apparatus), which is used to diffuse impurities or form a CVD layer, e.g., an insulating or a metal layer, on a wafer during the fabrication process of a semiconductor device and the batch-type CVD apparatus uses a pod as a wafer carrier. Hereinafter, a front, a rear, a left and a right side are defined with reference to FIG. 1. That is, the front side refers to where a pod stage 54 is located; the rear side refers to a side opposite to the front side, i.e., where a heater unit 13 is located; the left side refers to where a pod shelf 56 is located; the right side refers to a side opposite to the left side, i.e., where a housing 32 is located.

As shown in FIGS. 1 to 4, the batch-type CVD apparatus 1 includes a housing 2 having a nearly rectangle-parallelepiped body, a pressure-durable housing 3 installed in the rear portion of the housing 2, capable of maintaining a pressure therein lower than an atmospheric pressure (hereinafter referred to a negative pressure) under an airtight condition. An antechamber 4 of a loadlock type having a capacity in which it a boat may be installed is provided by using the pressure-durable housing 3. Installed at a middle height on a front wall of the pressure-durable housing 3 is a wafer loading-transferring chamber 5, which communicates with the antechamber 4, wherein the wafer loading-transferring chamber 5 is configured as a chamber (room) of the loadlock type since it is a part of the antechamber 4. Formed on a front wall of the wafer loading-transferring chamber 5 is a first wafer loading/unloading opening 6, which is closed or opened by a gate 7. Connected to the pressure-durable housing 3 are an exhaust line 8 for evacuating the antechamber 4 and the wafer loading-transferring chamber 5 to a negative pressure, and an inert gas supply line 8A for supplying an inert gas (nitrogen gas or the like) when the internal pressure of the antechamber 4 and the wafer loading-transferring chamber 5 are turned into the atmospheric pressure or when the wafers are cooled down.

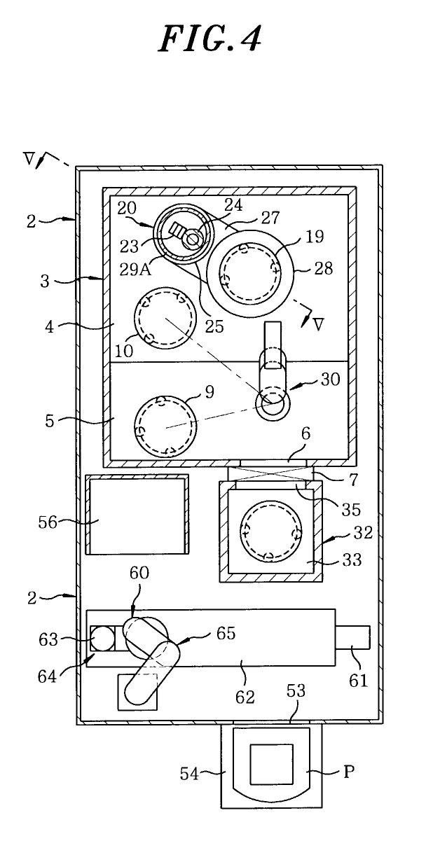

As shown in FIG. 4, installed in the wafer loading-transferring chamber 5 is a product wafer stocker 9 for storing temporarily product wafers (wafer to be a product) W. Installed in the antechamber 4 is a dummy wafer stocker 10 for storing dummy wafers (wafer for adjusting a processing condition and being a non-product). The stockers 9 and 10 have identical structures with a boat 19 which will be described later and are configured to maintain a plurality of wafers to be horizontal.

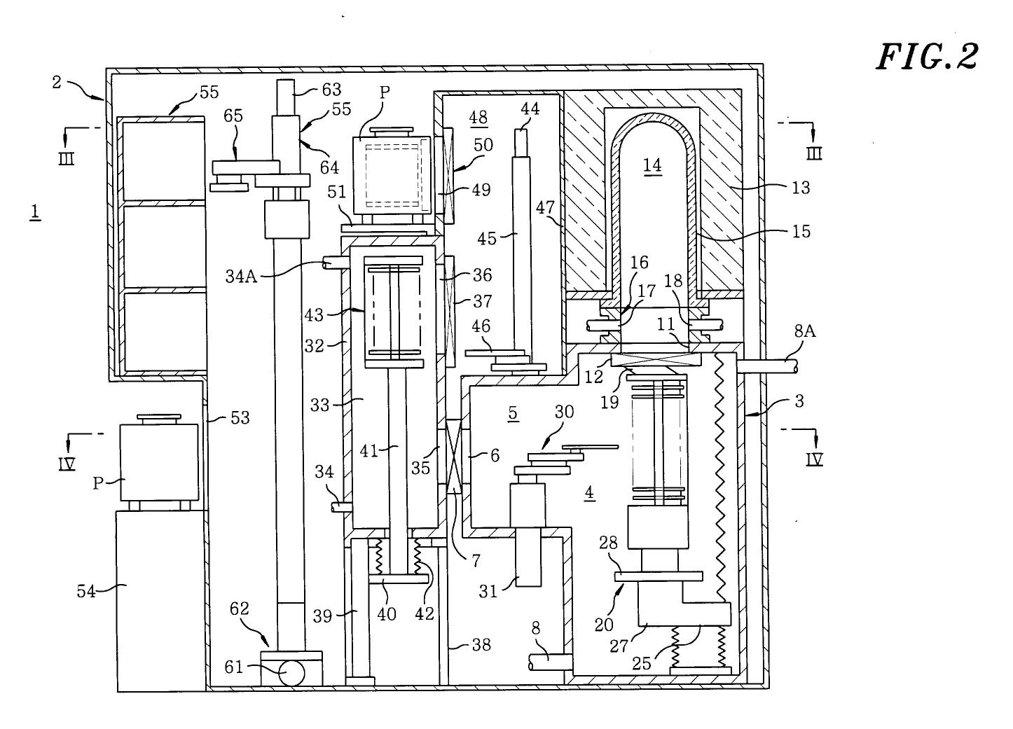

As shown in FIG. 2, installed on a top wall of the pressure-durable housing 3 is a boat loading/unloading opening 11, which is closed or opened by a shutter 12. Vertically installed at an upper portion of the pressure-durable housing 3 is a heater unit 13, and arranged in the inner portion of the heater unit 13 is a process tube 15, which forms a process room 14. The process tube 15 is of a cylindrical shape having a closed upper end and an open lower end and concentrically disposed in the heater unit 13, and the process room 14 is formed by a cylindrical hollow portion of the process tube 15. The process tube 15 is supported via a manifold 16 positioned on the top wall of the pressure-durable housing 3. Connected to the manifold 16 are a gas supply line 17 for introducing a source gas or a purge gas into the process room 14 having a cylindrical hollow shape and an exhaust line 18 for evacuating the inside of the process tube 15. The manifold 16 is concentrically arranged on the boat loading/unloading opening 11 of the pressure-durable housing 3.

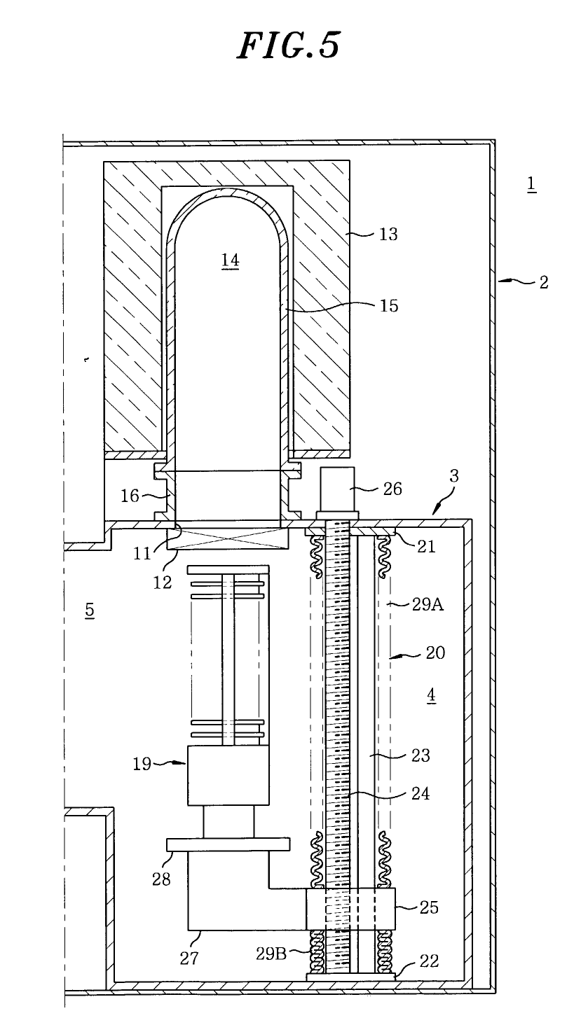

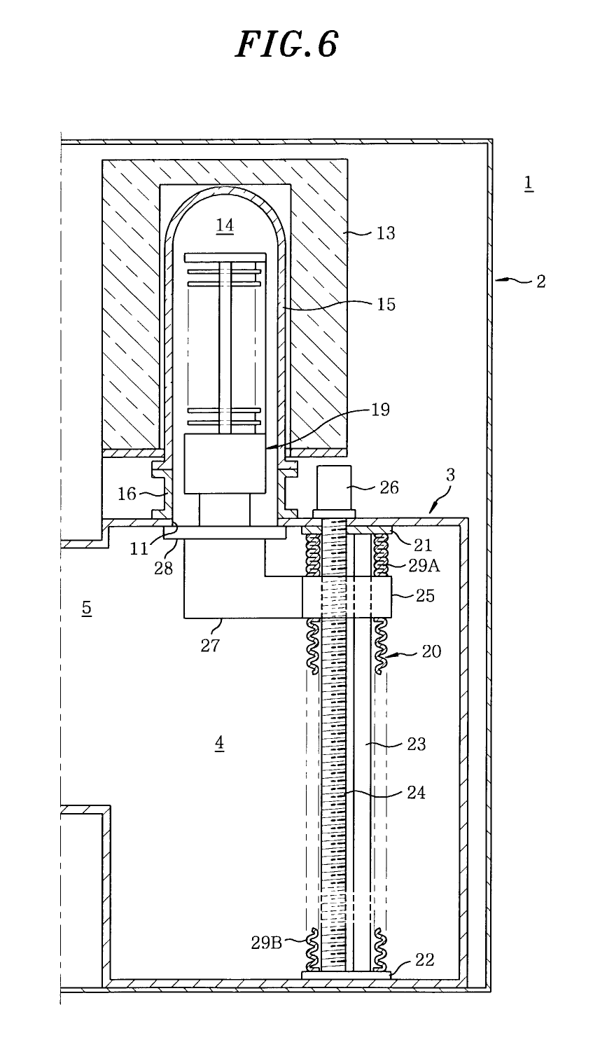

As shown in FIG. 4, installed at the rear and left corner portion of the antechamber 4 is a boat elevator 20 for raising or lowering the boat 19, which is disposed at a position deviated from the centerline extending between the front and rear portions of the antechamber 4. In the first preferred embodiment, by such an arrangement of the boat elevator 20 mentioned above, dead space of the antechamber 4 can be reduced. As shown in FIGS. 5 and 6, the boat elevator 20 may have a guide rail 23 and a feed screw shaft 24 attached vertically between an upper installing plate 21 and a lower installing plate 22, respectively. Inserted into the guide rail 23 is an elevating stage 25 which moves in a vertical direction. The elevating stage 25 is screw-combined to the feed screw shaft 24 so as to move in a vertical direction. Further, it is preferable to use a ball screw mechanism for the connection between the feed screw shaft 24 and the elevating stage 25 in order to confer smooth operation on the boat elevator 20 without increasing backlash. An upper portion of the feed screw shaft 24 is protruded to the outside of the antechamber 4 through the upper installing plate 21 and a top wall of the pressure-durable housing 3 and is connected to a motor 26 installed outside the antechamber 4 so as to be rotated thereby. Installed between the upper installing plate 21 and the elevating stage 25 is an upper bellows 29A, and installed between the lower installing plate 22 and the elevating stage 25 is a lower bellows 29B.

Horizontally protruded and installed on a side surface of the elevating stage 25 is an arm 27, and horizontally installed at an end portion of the arm 27 is a sealing cap 28. The sealing cap 28 is configured to air-tightly seal the boat loading/unloading opening 11 disposed in the pressure-durable housing 3 serving as a furnace mouth of the process tube 15 and to vertically support the boat 19 at the same time. The boat 19 is configured to be loaded into or unloaded from the process room 14 of the process tube 15 in accordance with the ascent and the descent of the sealing cap 28 accompanied with the ascending and the descending motion of the boat elevator 20 while horizontally holding a plural number, e.g., from 25 to 150, of the wafers W.

As shown in FIGS. 2 and 4, horizontally installed the wafer loading-transferring chamber (hereinafter referred to as a negative pressure loading-transferring chamber) 5 as a part of antechamber 4 is a wafer loading-transferring device 30 for loading and transferring the wafers W under a negative pressure. The wafer loading-transferring device (hereinafter referred to as a first wafer loading-transferring device) 30 is formed of a scara (selective compliance assembly robot arm) type robot. To prevent impurities from entering into the negative pressure loading-transferring chamber 5 and the antechamber 4, a motor 31 for driving the first wafer loading-transferring device 30 is installed outside a bottom wall of the negative pressure loading-transferring chamber 5.

Adjacently installed in front of the negative pressure loading-transferring chamber 5 is a housing 32 (hereinafter referred to as a buffer chamber housing) having an airtight performance and capable of maintaining the negative pressure therein, wherein the buffer chamber housing 32 is equipped with a buffer chamber 33 of the loadlock type in order to temporarily store a plurality of wafers W. Connected to a lower portion of the buffer chamber housing 32 is an exhaust line 34 for evacuating the buffer chamber 33 under a negative pressure, and connected to an upper portion of the buffer chamber housing 32 is an inert gas supply line 34A for supplying the inert gas (nitrogen gas or the like) when the buffer chamber 33 is turned to the atmospheric pressure or when the wafers are cooled down. Installed at a lower portion of the rear wall of the buffer chamber housing 32 is a second wafer loading/unloading opening 35, which is configured to be closed or opened by the gate 7. Further, installed at an upper portion of the rear wall of the buffer chamber housing 32 is the third wafer loading/unloading opening 36, which is configured to be closed or opened by a gate 37.

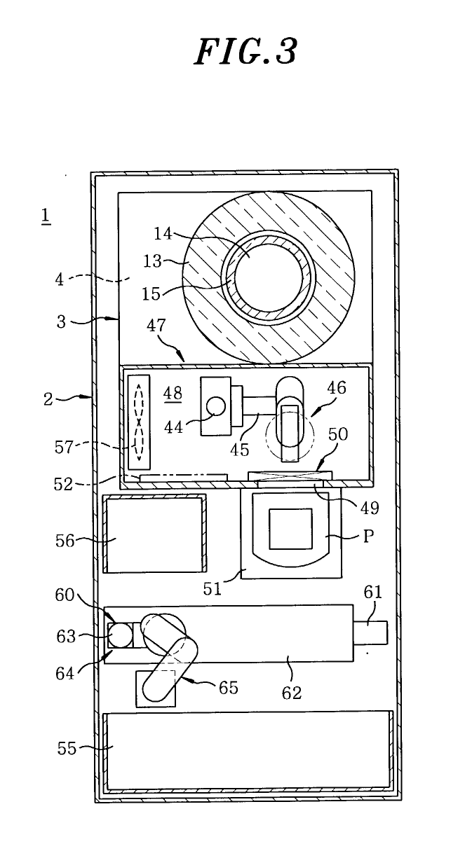

Installed on a trestle 38 is the buffer chamber housing 32, wherein installed inside the trestle 38 is an elevator 39. The elevator 39 is configured in order to lift or lower a supporting arm 40, wherein a prop 41 is configured to be vertically stood on an upper portion of the supporting arm 40. The prop 41 is inserted into an inner portion of the buffer chamber 33 by passing through a bottom wall of the buffer chamber housing 32. Installed between the bottom wall of the buffer chamber housing 32 and the supporting arm 40 is a bellows 42 in order to ensure an airtightness of the buffer chamber 33 during the ascent and descent of the prop 41. Installed on an upper portion of the prop 41 is a temporary storage stand 43 for temporarily holding a plurality of wafers W. The temporary storage stand 43 has an identical structure with the boat 19 and is configured such that a plurality of wafers W are horizontally maintained by a maintenance groove. Vertically installed on the top wall of the negative pressure loading-transferring chamber 5 is an elevator 45, which is driven by a motor 44 and configured to lift or lower the wafer loading-transferring device 46. The wafer loading-transferring device 46 is configured to load and transfer the wafers W under a pressure higher than the atmospheric pressure (hereinafter referred to as a positive pressure) To prevent a contamination from the impurities, installed in a loading-transferring chamber (hereinafter referred to as a positive pressure loading-transferring chamber) 48 formed with a housing 47 is the wafer loading-transferring device (hereinafter referred to a second wafer loading-transferring device) 46. Further, installed at a left end of the positive pressure loading-transferring chamber 48 is a clean air supplying unit 57 shown in FIG. 3, for providing a clean air therein.

As shown in FIGS. 2 and 3, installed on a front wall of the housing 47 of the positive pressure loading-transferring chamber 48 is a fourth wafer loading/unloading opening 49, which is configured to load/unload the wafers W to/from the positive pressure loading-transferring chamber 48. Installed by the fourth wafer loading/unloading opening 49 is a pod opener 50. The pod opener 50 has a loading port 51 for loading the pod P and a cap removing/restoring device 52 for removing or restoring a cap of the pod P disposed on the loading port 51, which is configured to close or open the wafer transfer path of the pod P, by removing or restoring the cap of the pod P disposed on the loading port 51 with the cap removing/restoring device 52. The loading port 51 disposed below the pod opener 50 is transferred by a pod transfer device 60 which will be described later.

As shown in FIGS. 1 to 3, installed in the front wall of the housing 2 is a pod loading/unloading opening 53. Installed in front of the pod loading/unloading opening 53 is the pod stage 54. The pod P is transferred to or from the pod stage 54 by a pod transport system such as a rail-guided vehicle (RGV). Installed in an upper portion of the housing 2 are a front pod shelf 55 and a rear pod shelf 56, respectively, which are configured to temporarily store a plurality of pods P therein.

Installed in a front portion of the housing 2 is the pod transfer device 60 for transferring the pod P among the front and rear pod shelves 55, 56 and the loading port 51. The pod transfer device 60 has a linear actuator 62 disposed in a bottom wall of the housing 2 along a left-right direction and driven by a motor 61, a pod elevator 64 moved by the linear actuator 62 along a left-right direction and driven by a motor 63, and a handling device 65 configured by the scala-type robot and raised or lowered by the pod elevator 64, wherein the pod P is handled by the handling device 65 and transferred in accordance with a three-dimensional movement of the linear actuator 62, the pod elevator 64 and the handling device 65.

Hereinafter, a thermal treatment process included in the IC manufacturing method in accordance with the first preferred embodiment of the present invention will now be described with reference to the foregoing batch-type CVD apparatus. Further, a batch process (bulk process) with respect to the product wafers W of less than 25 sheets loaded in one pod P will now be described.

The product wafers W to be heat-treated are transferred, under the condition of being loaded in the pod P of less than 25 sheets, by the pod transport system to the pod stage 54 disposed in the batch-type CVD apparatus 1 performing the thermal treatment process. The transferred pod P is temporarily stored after being transferred by the pod transfer device 60 to a place where the front shelf 55 or the rear shelf 56 is disposed.

The pod P which loads a first batched product wafers W is transferred and loaded at the loading port 51 disposed at lower portion of the pod opener 50 by the pod transfer device 60. The wafer transfer path of the pod P is opened when the cap of the loaded pod P is separated by the cap removing/restoring device 52 disposed beside the pod opener 50.

After the pod P is opened by the pod opener 50, the product wafers W are picked up from the pod P through the fourth wafer loading/unloading opening 49 by the second wafer loading-transferring device 46 installed in the positive pressure loading-transferring chamber 48 to thereby be unloaded into the positive pressure loading-transferring chamber 48 and are continuously transferred to the temporary storage stand 43 by being loaded into the buffer chamber 33 through the third wafer loading/unloading opening 36. The loading and transferring operation of the product wafers W performed by the second wafer loading-transferring device 46 is repeated until the designated product wafers W in the pod P are moved to the temporary storage stand 43. During the transferring operation of the product wafers W, the buffer chamber 33 is maintained at the atmospheric pressure since the third wafer loading/unloading opening 36 is opened and the negative pressure loading-transferring chamber 5, i.e., the antechamber 4 is maintained at a negative pressure since the second wafer loading/unloading opening 35 disposed at the buffer chamber 33 and the first wafer loading/unloading opening 6 disposed at the negative pressure loading-transferring chamber 5 are closed by the gate 7.

After having finished transferring operation of the dummy wafers, the wafer transfer path of the pod P is closed. The closed pod P is transferred and stored by the pod transfer device 60 on the front pod shelf 55 or the rear pod shelf 56.

After the first batched product wafers W loaded in the pod P are completely moved to the temporary storage stand 43, the pod P with the dummy wafers (not shown) is picked up from the front pod shelf 55 or the rear pod shelf 56 by the pod transfer device 60 and is transferred and loaded on the loading port 51 of the pod opener 50. Subsequently, by an identical operation with the case of the product wafers, the dummy wafers having a predetermined number of sheets are moved from the pod P to the temporary storage stand 43. During the moving operation of the dummy wafers, the buffer chamber 33 is maintained at the atmospheric pressure since the third wafer loading/unloading opening 36 is opened, and the negative pressure loading-transferring chamber 5 and the antechamber 4 is maintained at the negative pressure since the second wafer loading/unloading opening 35 disposed in the buffer chamber 33 and the first wafer loading/unloading opening 6 located in the negative pressure loading-transferring chamber 5 are closed by the gate 7.

After having finished moving operation of the dummy wafers, the wafer transfer path of the pod P is closed. The closed pod P is transferred and stored by the pod transfer device 60 at the front pod shelf 55 or the rear pod shelf 56.

If the product wafers W and dummy wafers having the predetermined number of sheets are charged to the temporary storage stand 43, the third wafer loading/unloading opening 36 is closed by the gate 37. In the following operation, the temporary storage stand 43 is lowered to a position of the second wafer loading/unloading opening 35 by the elevator 39 and simultaneously, the buffer chamber 33 is evacuated to a negative pressure through the exhaust line 34. In the evacuation process described above, since a capacity of the buffer chamber 33 is set to be small, an evacuating time down to a predetermined pressure level will be short. For example, the predetermined pressure level of about 1.333×10⁻² Pa can be reached in several minutes.

If the pressure of the buffer chamber 33 is decompressed to the predetermined pressure level, the second wafer loading/unloading opening 35 and the first wafer loading/unloading opening 6 disposed in the negative pressure loading-transferring chamber 5 are opened by the gate 7. In the opening operation of the gate 7, the internal pressure of the negative pressure loading-transferring chamber 5 and the antechamber 4 are maintained at the predetermined pressure level. Accordingly, there is no need to evacuate the negative pressure loading-transferring chamber 5 and the antechamber 4 to a vacuum every time when the gate 7 is opened.

Next, the product wafers W and the dummy wafers are loaded into the negative pressure loading-transferring chamber 5 and the antechamber 4 by the first wafer loading-transferring device 30, located in the negative pressure loading-transferring chamber 5, which sequentially picks up the product wafer W and the dummy wafer in one sheet or in plural sheets from the temporary storage stand 43 through the second wafer loading/unloading opening 35 and the first wafer loading/unloading opening 6 disposed in the negative loading-transferring chamber 5 and are further charged to the boat 19 disposed in the antechamber 4. If the product wafers W and the dummy wafers are completely charged to the boat 19, the second wafer loading/unloading opening 35 disposed in the buffer chamber 33 and the first wafer loading/unloading opening 6 disposed in the negative pressure loading-transferring chamber 5 are closed by the gate 7.

In the moving operation of the product wafers W and the dummy wafers from the temporary storage stand 43 to the boat 19 by the first wafer loading-transferring device 30, the buffer chamber 33, the antechamber 4 and the negative pressure loading-transferring chamber 5 are evacuated to the vacuum condition, so that the oxygen or the moisture disposed therein is removed beforehand. Therefore, there is formed no natural oxide film on the product wafers W in the process being charged or the product wafer W which have already been charged. Further, during the moving operation of the product wafers W and the dummy wafers from the temporary storage stand 43 to the boat 19 by the first wafer loading-transferring device 30, the boat loading/unloading opening 11 is closed by a shutter 12, which prevents a high temperature ambience of the process tube 15 from being introduced into the antechamber 4. Therefore, the product wafers W in the process of being charged and the product wafers W which have already been charged are not exposed to the high temperature ambience, so that the adverse effect caused by the exposure to the high-temperature ambience, e.g., natural oxidation of the wafers, can be prevented.

The dummy wafers may be transferred and loaded to the dummy wafer stocker 10 disposed in the antechamber 4 along the identical path with the path described above before processing the wafer and then be loaded and transferred to the boat 19 by the first wafer loading-transferring device 30.

As shown in FIGS. 2 and 5, when the predetermined number of the product wafers W and dummy wafers are charged to the boat 19, the boat loading/unloading opening 11 is opened by moving the shutter 12. In the opening operation of the shutter 12, the process room 14 disposed in the process tube 15 is already evacuated to the vacuum condition, which is maintained at the predetermined pressure level. Continuously, as shown in FIG. 6, the boat 19 supported by the sealing cap 28 is raised by the elevating stage 25 and loaded into the process room 14 disposed in the process tube 15. When the boat 19 reaches its uppermost position, the process room 14 disposed in the process tube 15 becomes a hermetically closed state since the boat loading/unloading opening 11 is blocked as a sealed condition by the periphery of the top surface of the sealing cap 28 supporting the boat 19. In the loading of the boat 19 into the process room 14, since the antechamber 4 is evacuated to the vacuum condition so that the oxygen or the moisture disposed therein is removed beforehand, oxygen or moisture is firmly prevented from being introduced into the process room 14 while loading the boat 19 thereinto.

Thereafter, the process room 14 disposed in the process tube 15 is evacuated by the exhaust line 18 to a predetermined pressure under the condition of airtightly closing the process room 14 and is then heated to a predetermined temperature by the heater unit 13 and thereafter a predetermined raw gas is provided by the gas supply line 17 to a predetermined flow quantity. By the above process, a thermal treatment in accordance with a predetermined processing condition is performed on the product wafer W.

Here, a processing steps of the second batched product wafers W while performing the thermal treatment on the first batched product wafers W will now be described. The pod P with the second batched product wafers W is transferred and loaded from either the front pod shelf 55 or the rear pod shelf 56 to the loading port 51 located below the pod opener 50 by the pod transfer device 60. The cap of the pod P is separated from the pod by the cap removing/restoring device 52, so that the wafer transfer path of the pod P is opened.

After the pod P is opened by the pod opener 50, the product wafers W are picked up from the pod P through the fourth wafer loading/unloading opening 49 by the second wafer loading-transferring device 46 disposed in the positive pressure loading-transferring chamber 48 to be unloaded first into the positive pressure loading-transferring chamber 48, and then loaded into the buffer chamber 33 through the third wafer loading/unloading opening 36 and thereafter, moved to the temporary storage stand 43. The loading and transferring operation of the product wafers W performed by the second wafer loading-transferring device 46 is repeated until the designated number of product wafers W disposed in the pod P are moved to the temporary storage stand 43. During the moving operation of the product wafers, the interior of the buffer chamber 33 is maintained at the atmospheric pressure since the third wafer loading/unloading opening 36 is opened. The second wafer loading/unloading opening 35 disposed in the buffer chamber 33 and the first wafer loading/unloading opening 6 disposed in the negative pressure loading-transferring chamber 5 are closed by the gate 7, so that the negative pressure loading-transferring chamber 5 and the antechamber 4 is maintained at a negative pressure.

After having completed moving operation, the pod P is closed and the closed pod P is transferred and stored by the pod transfer device 60 to either the front pod shelf 55 or the rear pod shelf 56.

If the predetermined number of the product wafers W are charged to the temporary storage stand 43, the third wafer loading/unloading opening 36 disposed in the buffer chamber 33 is closed by the gate 37. Subsequently, the temporary storage stand 43 is lowered to a position of the second wafer loading/unloading opening 35 by the elevator 39 and simultaneously, the buffer chamber 33 is evacuated to the negative pressure by the exhaust line 34. In the exhaustion of the buffer chamber 33, since the capacity of the buffer chamber 33 is set to be small, the exhausting time to reach a predetermined pressure value in the buffer chamber 33 can be short.

If the buffer chamber 33 is decompressed to a pressure value predetermined beforehand, the second wafer loading/unloading opening 35 and the first wafer loading/unloading opening 6 disposed in the negative pressure loading-transferring chamber 5 are opened by the gate 7. During the opening operation of the gate 7, the internal pressure of the negative pressure loading-transferring chamber 5 and the antechamber 4 is maintained at a pressure value predetermined in advance.

Continuously, the second batched product wafers W are sequentially picked up from the temporary storage stand 43 in one sheet or in plural sheets through the second wafer loading-transferring opening 35 and the first wafer loading/unloading opening 6 of the negative pressure loading-transferring chamber 5 by the first wafer loading-transferring device 30 disposed in the negative pressure loading-transferring chamber 5 to thereby be loaded into the negative pressure loading-transferring chamber 5 and are simultaneously charged to the product wafer stocker 9 disposed in the negative pressure loading-transferring chamber 5. After the product wafers W are completely charged to the product wafer stocker 9, the second wafer loading/unloading opening 35 disposed in the buffer chamber 33 and the first wafer loading/unloading opening 6 disposed in the negative pressure loading-transferring chamber 5 are closed by the gate 7. During the moving operation of the second batched product wafers W from the temporary storage stand 43 to the product wafer stocker 9 by the first wafer loading-transferring device 30, since the buffer chamber 33, the antechamber 4 and the negative pressure loading-transferring chamber 5 has already been evacuated to the vacuum condition so that the oxygen or the moisture therein is removed in advance, there is formed no natural oxide film on the product wafers W which are in the process being charged and the product wafers W which already have been charged. In addition, during the moving operation of the second batched product wafers W from the temporary storage stand 43 to the product wafer stocker 9 by the first wafer loading-transferring device 30, the boat loading/unloading opening 11 is closed by the sealing cap 28, so that a high temperature ambience in the process tube 15 is prevented from being introduced into the antechamber 4. Therefore, the product wafers W which are in the process being charged and the product wafers W which have already been charged are not exposed to the high-temperature ambience, so that the adverse effect caused by the exposure to the high-temperature ambience, e.g., natural oxidation of the wafers, can be prevented.

Further, the transfer from the pod P of the second batched product wafers W to the temporary storage stand 43 of the buffer chamber 33 becomes possible after the first batched product wafers W are completely transferred from the temporary storage stand 43 to the boat 19 and further the gate 7 is closed. In other words, after the gate 7 is closed, the boat 19 charged with the first batched product wafers W can be loaded into the process room 14 disposed in the process tube 15 under the vacuum condition and simultaneously, the second batched product wafers W can be transferred from the pod P to the temporary storage stand 43 disposed in the buffer chamber 33 under the atmospheric pressure.

Further, transferring operation of the second batched product wafers W from the temporary storage stand 43 to the product wafer stocker 9 disposed in the negative pressure loading-transferring chamber 5 can be performed after the boat 19 charged with the first batched product wafers W is loaded into the process room 14 disposed in the process tube 15 and then, the boat loading/unloading opening 11 is closed by the sealing cap 28. In other words, after the boat loading/unloading opening 11 is closed by the sealing cap 28, a thermal treatment on the first batched product wafers W can be performed and simultaneously, the second batched product wafers W can be transferred from the temporary storage stand 43 disposed in the buffer chamber 33 to the product wafer stocker 9 disposed in the negative pressure loading-transferring chamber 5 under the vacuum condition.

If a predetermined setting time for processing the first batched product wafers W is passed, the boat 19 is lowered by the elevating stage 25 of the boat elevator 20, so that the boat 19 holding the product wafers W thermally treated is unloaded into the antechamber 4. In the meantime, the antechamber 4, the negative pressure loading-transferring chamber 5 and the buffer chamber 33 are kept at the negative pressure. If the boat 19 is unloaded to the antechamber 4, the boat loading/unloading opening 11 is closed by the shutter 12. Thereafter, the inert gas, e.g., nitrogen, is provided to the antechamber 4 by the inert gas supply line 8A connected to the pressure-durable housing 3, so that the processed wafer disposed on the boat 19 is cooled. Thereafter, the antechamber 4 is decompressed to the vacuum condition again.

Subsequently, the first wafer loading/unloading opening 6 disposed in the negative pressure loading-transferring chamber 5 and the second wafer loading-transferring opening 35 disposed in the buffer chamber 33 are opened by the gate 7. Continuously, the heat-treated first batched product wafers W are sequentially picked up from the boat 19 of the antechamber 4 by the first wafer loading-transferring device 30 disposed in the negative pressure loading-transferring chamber 5 and then are unloaded to the buffer chamber 33 through the first wafer loading/unloading opening 6 and the second wafer loading/unloading opening 35, to be charged to the temporary storage stand 43 of the buffer chamber 33. Tf the heat-treated product wafers W are completely moved from the boat 19 to the temporary storage stand 43, the first wafer loading/unloading opening 6 of the negative pressure loading-transferring chamber 5 and the second wafer loading/unloading opening 35 of the buffer chamber 33 are closed by the gate 7.

Since the moving operation of the heat-treated product wafers W by the first wafer loading-transferring device 30 from the boat 19 to the temporary storage stand 43 is performed in the buffer chamber 33, the negative pressure loading-transferring chamber 5 and the antechamber 4 maintained at the negative pressure, the formation of the natural oxide film on the surface of the processed product wafers W and the adhesion of impurities thereon can be prevented.

If the moving operation of the first batched product wafers W is finished, the dummy wafers used for the first batched product wafers W are transferred from the boat 19 to the dummy wafer stocker 10 by the first wafer loading-transferring device 30. Thereafter, the dummy wafers are kept waiting in the dummy wafer stocker 10.

The second batched product wafers W are sequentially discharged from the product wafer stocker 9 to the boat 19 by the first wafer loading-transferring device 30. If the moving operation of the second batched product wafers W from the product wafer stocker 9 to the boat 19 is finished, the dummy wafers stored in the dummy wafer stocker 10 are sequentially charged to the boat 19 by the first wafer loading-transferring device 30. At this time, since the antechamber 4 and the negative pressure loading-transferring chamber 5 are also maintained at the negative pressure, there is formed no natural oxide film on the product wafers W in the process of being charged and the product wafers W which have already been charged. Further, during the moving operation of the second batched product wafers W from the product wafer stocker 9 to the boat 19 by the first wafer loading-transferring device 30, the boat loading/unloading opening 11 is closed by the shutter 12, so that the high temperature ambience of the process tube 15 is prevented from being flowed into the antechamber 4. Therefore, the product wafers W in the process of being charged and the product wafers W which have already been charged are not exposed to the high temperature ambience, so that an adverse effect caused by the exposure to the high-temperature ambience, e.g., natural oxidation of the wafers, can be prevented.

If the second batched product wafers W and dummy wafers are charged to the boat 19, the boat loading/unloading opening 11 is opened with the shutter 12, and then the boat 19 is loaded into the process room 14. If the boat loading/unloading opening 11 is closed with the sealing cap 28 after the boat 19 reaches an uppermost position thereof, a predetermined thermal treatment is performed on the second batched product wafers W in the process room 14, under the identical condition with the case of the first batched product wafers W mentioned above.

In case the first batched product wafers W are moved to the temporary storage stand 43, the inert gas, e.g., nitrogen gas, is provided to the buffer chamber 33 by the inert gas supply line 34A connected to the top portion of the buffer chamber housing 32, so that the processed wafers are cooled again. If the loadlock of the buffer chamber 33B is released, the third wafer loading/unloading opening 36 disposed in the buffer chamber 33 is opened by the gate 37 and simultaneously, the temporary storage stand 43 is raised to a position of the third wafer loading/unlading opening 36 by the elevator 37. Subsequently, the product wafers W processed completely from the temporal storage stand 43 disposed in the buffer chamber 33 are sequentially picked up through the third wafer loading/unloading opening 36 by the second wafer loading-transferring device 46 disposed in the positive pressure loading-transferring chamber 48 to be unloaded into the positive pressure loading-transferring chamber 48.

In the meantime, the empty pod P to load the processed first batched product wafers W is transferred and loaded on the loading port 51 of the pod opener 50 by the pod transfer device 60 and, thereafter, the wafer transfer path is opened if the cap is stripped with the cap removing/restoring device 52 of the pod opener 50. The first batched product wafers W unloaded from the buffer chamber 33 to the positive pressure loading-transferring chamber 48 are charged to the pod P by the second wafer loading-transferring device 46. If the heat-treated product wafers W are completely loaded into the pod P, the cap of the pod P is put to the wafer loading opening by the cap removing/restoring device 52 of the pod opener 50 to thereby close the pod.

The closed pod P is transferred and loaded from the top of the loading stand 51 to the pod stage 54 by the pod transfer device 60 and then is properly transferred to a subsequent process by the transport system. Further, the moving operation of the first batched product wafers W from the buffer chamber 33 to the pod P is simultaneously progressed while performing the moving operation of the second batched product wafers W or/and while the thermal treatment. Accordingly, a deterioration of the throughput of the batch-type CVD apparatus can be prevented.

Subsequently, by repeating the operation following the aforementioned second batched product wafers W afterward, a batch process on the product wafers W of less than 25 sheets loaded in a pod P is sequentially performed.

Further, transferring operation for the second batched product wafers W from the product wafer stocker 9 to the boat 19 becomes possible after the heat-treated first batched product wafers W are transferred from the boat 19 to the temporary storage stand 43 disposed in the buffer chamber 33. Further, if the gate 7 is closed, the second batched product wafers W can be transferred from the product wafer stocker 9 to the boat 19 under the vacuum condition and simultaneously, the heat-treated first batched product wafers W can also be transferred from the temporary storage stand 43 of the buffer chamber 33 to the pod P under the atmospheric pressure.

Following effects can be achieved by the preferred embodiments of the present invention.

1) By installing the buffer chamber of the loadlock type in the antechamber of the loadlock type adjoining to the process room, the loading and unloading of the wafers between the pod and the buffer chamber can be performed under the atmospheric pressure and further the loading and unloading of the wafers between the buffer chamber and the antechamber can be performed under the vacuum condition so that the formation of the natural oxide film on the surface of the processed wafers and the adhesion of the impurities thereon can be prevented.

2) By arranging the pod opener at the top portion of the buffer chamber and arranging the second wafer loading-transferring device at the top portion of the negative pressure loading-transferring chamber adjoining the antechamber, the pod opener and the second wafer loading-transferring device can be prevented from protruding toward the front of the negative pressure loading-transferring chamber, so that the width of the batch-type CVD apparatus can be set to be narrow and thereby the area occupied by the apparatus can be made small.

3) By installing the stocker for the dummy wafers and the stocker for the product wafers in the antechamber of the loadlock type and the negative pressure loading-transferring chamber, the time needed for charging or discharging the boat having the product wafers and the dummy wafers from the antechamber can be shortened such that the throughput of the batch-type CVD apparatus can be increased. Especially, the time for loading and transferring the product wafers of a subsequent batch to the boat can be shortened.

4) By separating the boat elevator installed in the antechamber of the loadlock type and the elevator of the temporary storage stand installed in the buffer chamber from the antechamber and the buffer chamber by the bellows, respectively, contamination of the antechamber and the buffer chamber by the boat elevator and the elevator of the temporary storage stand can be prevented so that the contamination of the wafers from the impurities or the organic materials can be prevented.

5) By arranging the boat elevator to be inclined toward the centerline extending the front and rear direction of the antechamber, the dead space of the corner portion of the antechamber can be utilized and therefore, the width of the batch-type CVD apparatus and the area occupied by the apparatus can be set to be small.

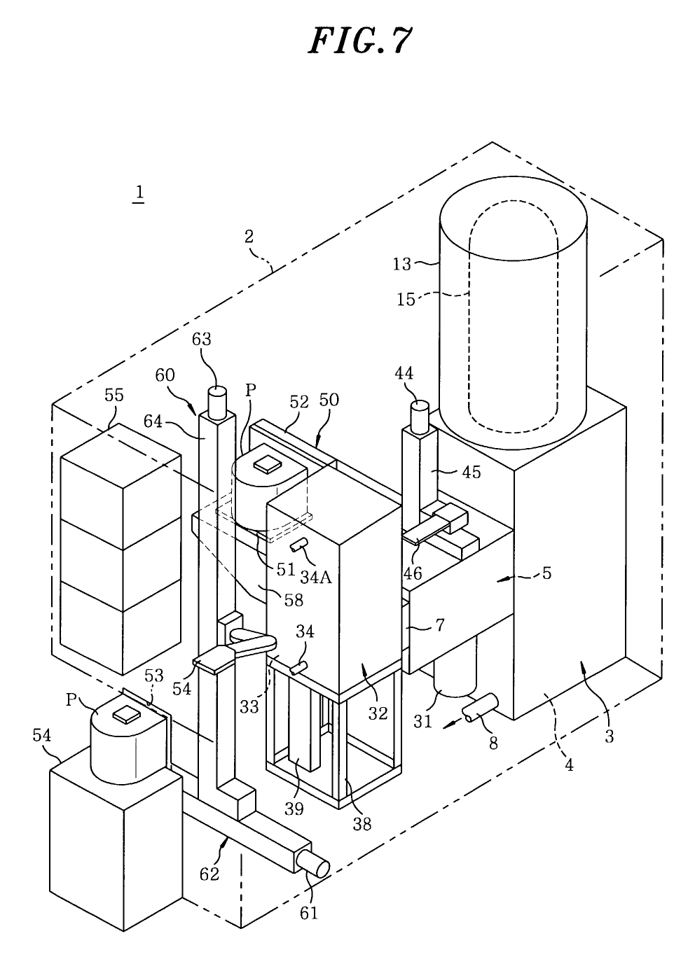

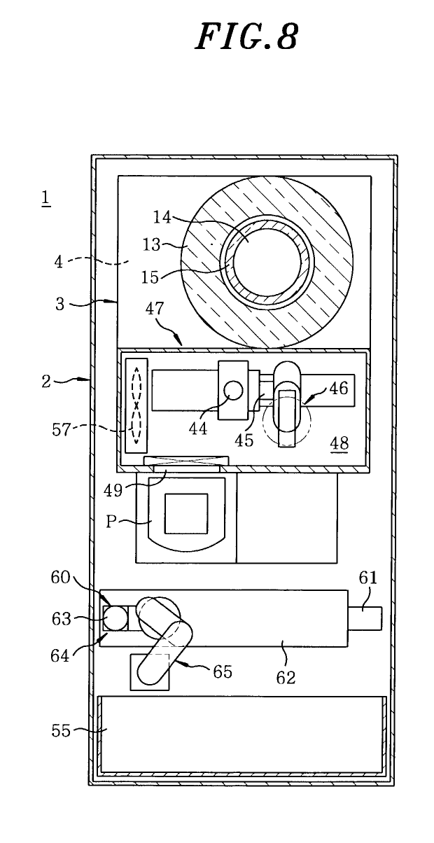

FIG. 7 represents a partially omitted perspective view of a batch-type CVD apparatus 1 in accordance with a second embodiment of the present invention and FIG. 8 shows a horizontal cross-sectional view of the batch-type CVD apparatus 1 of FIG. 7.

The batch-type CVD apparatus in accordance with the second preferred embodiment of the present invention is different from that in accordance with the first preferred embodiment in that the pod opener 50 is arranged at the side surface of the buffer chamber housing 32 and the second wafer loading-transferring device 46 is configured to move horizontally. In other words, the loading port 51 of the pod opener 50 is supported by a trestle 58 installed at the side surface of the buffer chamber housing 32, and the cap removing/restoring device 52 of the pod opener 50 is configured to reciprocatively move along the top and bottom direction thereof.

In the second preferred embodiment, by arranging the pod opener 50 at the side of the buffer chamber 32, a protrusion of the pod opener 50 and the second wafer loading-transferring device 46 to the front direction of the negative pressure loading-transferring chamber can be avoided as in the first preferred embodiment, so that the width of the batch-type CVD apparatus can be set to be narrow and thereby the area occupied by the apparatus can be set to be small.

Further, the present invention is not limited by the preferred embodiments mentioned above, but should be noted that the preferred embodiments described above can be modified without departing from the scope of the invention.

For instance, the number of the product wafers to be processed at a time is not limited to a number less than 25 sheets possible to be loaded in a pod and can be set as a number bigger than 25 sheets.

The stocker for the dummy wafers is installed in the antechamber or the negative pressure loading-transferring chamber, and the dummy wafers stored in the stocker are properly outputted to be charged to the boat. However, the dummy wafers can be reserved in the boat in order to periodically or non-periodically be exchanged with or can be fixed in the boat.

The substrate processing apparatus in accordance with the present invention can also be used in an oxidation treatment, a diffusion process, a plasma treatment, a sputtering process, a dry etching process and the combination thereof.

While the invention has been shown and described with respect to the preferred embodiments, it will be understood by those skilled in the art that various changes and modifications may be made without departing from the spirit and scope of the invention as defined in the following claims.

What is claimed is:

1. A substrate processing apparatus comprising:
a process room for treating one or more substrates;
an antechamber of a loadlock type installed to be adjoined to the process room; and
a buffer chamber installed to be adjoined to the antechamber, the buffer chamber being maintained at an atmospheric pressure while the one or more substrates are transferred from a carrier for accommodating the one or more substrates to the buffer chamber and at a vacuum condition while the one or more substrates are transferred from the buffer chamber to the antechamber,
wherein the buffer chamber is equipped with a loading port for loading the carrier at a top or a side portion thereof.

2. The substrate processing apparatus of the claim 1, further comprising a first substrate loading-transferring device for transferring the one or more substrates between the buffer chamber and the antechamber, and a second substrate loading-transferring device for transferring the one or more substrates between the carrier loaded in the loading port and the buffer chamber, wherein the second substrate loading-transferring device is arranged above an upper portion of the first substrate loading-transferring device.

3. A substrate processing apparatus comprising:
a process room for treating one or more substrates;
an antechamber of a loadlock type installed to be adjoined to the process room; and
a buffer chamber installed to be adjoined to the antechamber, the buffer chamber being maintained at an atmospheric pressure while the one or more substrates are transferred from a carrier for accommodating the one or more substrates to the buffer chamber and at a vacuum condition while the one or more substrates are transferred from the buffer chamber to the antechamber,
wherein the antechamber is equipped with a stocker for storing one or more product substrates or/and one or more dummy substrates therein.

4. A substrate processing apparatus comprising:
a process room for treating one or more substrates;
an antechamber installed to be adjoined to the process room, the antechamber being of a loadlock type; and
an elevator for loading the one or more substrates to and unloading the one or more substrates from the process room, the elevator being installed in the antechamber,
wherein the elevator is arranged at a corner portion of the antechamber in order to reduce dead space.

5. A method for fabricating a semiconductor device comprising the steps of:
transferring one or more substrates from a carrier for accommodating the one or more substrates to a buffer chamber at an atmospheric pressure;
transferring the one or more substrates from the buffer chamber to an antechamber of a loadlock type at a vacuum condition;
transferring the one or more substrates from the antechamber to a process room at a vacuum condition; and
processing the one or more substrates in the process room,
wherein the buffer chamber is installed to be adjoined to the antechamber, the buffer chamber is equipped with a loading port for loading the carrier at a top or a side portion thereof, and the antechamber is installed to be adjoined to the process room.
